(19) United States
(12) Patent Application Publication
(10) Pub. No.: US 2004/0192502 A1
(43) Pub. Date: Sep. 30, 2004

(54) Control method and device of automatic transmission

(75) Inventors: Fuminori Suzuki, Okazaki-city (JP); Akira Takagi, Obu-city (JP)

Correspondence Address: NIXON & VANDERHYE, PC, 1100 N GLEBE ROAD, 8TH FLOOR, ARLINGTON, VA, 22201-4714, US

(73) Assignee: DENSO CORPORATION, Aichi-pref (JP)

(21) Appl. No.: 10/801,034

(22) Filed: Mar. 16, 2004

(30) Foreign Application Priority Data
Mar. 24, 2003 (JP) 2003-80143

(51) Int. Cl. F16H 61/48; F16H 31/00

(52) U.S. Cl. 477/127; 475/118

(57) ABSTRACT

An automatic transmission is controlled by using a hydraulic circuit employing a mechanical pump driven by an engine, a motor pump, and oil passages to which the mechanical pump and the motor pump supply a fluid. More specifically, when a change of state in the automatic transmission and the hydraulic circuit is detected, while the engine is revolving without any aid of a starter so that the mechanical pump supplies the fluid to the oil passages, the motor pump is driven.

### CROSS REFERENCE TO RELATED APPLICATIONS

This application is based upon, claims the benefit of priority of, and incorporates by reference Japanese Patent Application No. 2003-80143 filed Mar. 24, 2003.

### BACKGROUND OF THE INVENTION

1. Field of the Invention

The present invention relates to a control method and a control device of an automatic transmission.

2. Description of the Related Art

Generally, a control device for controlling an automatic transmission that uses a hydraulic circuit including a mechanical pump driven by an internal combustion engine (hereinafter, referred to simply as an “engine”) or a motor pump is known. Japanese Patent Laid-Open Publication No. 2001-99282 discloses a method for driving not only a mechanical pump but also a motor pump when an engine is restarted after the engine stops in a control device for controlling an automatic transmission of a vehicle including an idle stop system. With such a configuration, an oil passage of the hydraulic circuit is filled with a fluid along with the restarting of the engine, thereby preventing generation of a delay in response of the hydraulic circuit.

When input torque is increased in the automatic transmission, sliding occurs in a friction element in an engaged state depending on the pressure of the fluid supplied from the oil passage of the hydraulic circuit to the friction element. As a result, the gear position will not be kept.

Moreover, when a plurality of oil passages for supplying a fluid to a plurality of friction elements are switched by a manual valve of the hydraulic circuit, the viscosity of the fluid is lowered as the temperature of the fluid is lowered to delay the supply of the fluid to the friction elements. In this case, with the engagement of the friction elements, a large shock is generated.

In any of the cases described above, the problems can be solved by increasing the amount of fluid supplied to the oil passage. In the device described in the above-mentioned patent publication however, the motor pump is stopped after the engine is started. Therefore, even if a change of state such as an increase in input torque or a drop in fluid temperature is generated in the automatic transmission or the hydraulic circuit while the engine is running, the amount of fluid supplied to the oil passage is not increased. Therefore, the above-described change of state cannot be properly processed. It is conceivable that this device uses a mechanical pump having a high discharge ability to increase in advance the amount of fluid to be supplied. In such a case however, a large amount of fluid is supplied even when it is not needed. Therefore, since an excessive amount of energy is consumed to supply an unnecessary amount of fluid, the fuel efficiency of the engine for driving the mechanical pump is also lowered.

### SUMMARY OF THE INVENTION

In view of the above problems, an embodiment of the present invention has an object of providing a control method and a control device for an automatic transmission that deals with a change of state generated in the automatic transmission and a hydraulic circuit during the revolving of the engine while preventing the fuel efficiency of the engine from being lowered.

According to a first and an eleventh aspect of the invention, the motor pump is driven when a change of state in the automatic transmission and the hydraulic circuit is detected while the engine is revolving without any aid of a starter, that is, complete ignition of the engine is achieved to allow the engine to be in a continuous operating state so that the mechanical pump supplies a fluid to the oil passage of the hydraulic circuit. As a result, even if a change of state, which requires the amount of fluid supplied to the oil passage to be increased, occurs during the engine operation, the change of state can be dealt with by driving the motor pump. Moreover, since the amount of fluid supplied to the oil passage can be increased by driving the motor pump without enhancing the discharge ability of the mechanical pump, the fuel efficiency of the engine can be prevented from being lowered. When input torque is increased in the automatic transmission, sliding occurs in a friction element in an engaged state depending on a pressure of the fluid supplied from the oil passage to the friction element.

According to a second and a twelfth aspect of the invention, the motor pump is driven when a change of the input torque exceeding a predetermined value is detected in the automatic transmission. By driving the motor pump, the amount of fluid supplied from the oil passage to the friction element can be increased to increase a pressure of the supplied fluid. Therefore, even if the input-side torque is increased, a slide hardly occurs in the friction element in an engaged state.

When an input shaft and an output shaft of a torque converter are directly connected to each other by a lock-up clutch in an automatic transmission, the shafts slide in the directly connected portion to increase a difference in number of revolutions between the shafts if a pressure of the fluid supplied from the oil passage to the lock-up clutch is low.

According to a third and a thirteenth aspect of the invention, the motor pump is driven when a change of a difference in the number of revolutions between the input shaft and the output shaft exceeds a predetermined value is detected in the automatic transmission. By driving the motor pump, the amount of fluid supplied from the oil passage to the lock-up clutch can be increased to increase a pressure of the supplied fluid. Therefore, even if sliding occurs between the input shaft and the output shaft when the shafts are directly connected to each other, the sliding can be immediately stopped.

According to a fourth and a fourteenth aspect of the invention, the motor pump is driven when a state where the input shaft and the output shaft are directly connected to each other and a change in a difference in the number of revolutions between the input shaft and the output shaft exceeds a predetermined value are detected in the automatic transmission. As a result, since the motor pump can be driven at the right moment when prevention of sliding between the directly connected shafts is required, energy can be conserved. During gear position shifting in the automatic transmission, the friction element emits heat, for example, as it transits from a disengaged state to an engaged state.

According to a fifth and fifteenth aspect of the invention, the motor pump is driven when shifting of a gear position is detected in the automatic transmission. By driving the motor pump, the amount of fluid supplied from the oil passage to a lubricating circuit can be increased to enhance the lubricating performance to the friction element. Therefore, the friction element can be prevented from emitting heat during gear position shifts.

When switching between a plurality of oil passages for supplying the fluid to a plurality of friction elements is performed by a manual valve of the hydraulic circuit, a larger shock is generated when transitioning the friction elements from a disengaged state to an engaged state, that is, with the engagement of the friction elements, the fluid temperature becomes lower.

According to a sixth and sixteenth aspect of the invention, the motor pump is driven when a change of the fluid temperature becomes lower than a predetermined value and the change is detected in the hydraulic circuit. By driving the motor pump, the amount of fluid supplied from each of the oil passages to each of the friction elements can be increased. Therefore, even if the fluid temperature is low when the manual valve switches the oil passages by a command of changing a shift position, the fluid can be quickly supplied to the friction elements. Thus, shock generated with the engagement of the friction elements can be reduced.

According to a seventh and seventeenth aspect of the invention, the motor pump is driven when a change of the oil passages, which are switched by the manual valve, is detected in the hydraulic circuit. By driving the motor pump, the amount of fluid supplied from each of the oil passages to each of the friction elements can be increased. Therefore, when the manual valve switches the oil passages by a command of changing the shift position, the fluid can be quickly supplied to the friction elements regardless of the fluid temperature. Thus, shock generated with the engagement of the friction elements can be reduced.

According to an eighth and an eighteenth aspect of the invention, the motor pump is driven when a change of the fluid temperature becomes lower than a predetermined value and the change is detected in the automatic transmission. By driving the motor pump, the amount of fluid supplied from the oil passage to a warmer can be increased. As a result, a large amount of fluid is forced to the warmer to be warmed even if the fluid temperature drops. The performance of the automatic transmission can be improved by using the warmed fluid in, for example, the automatic transmission.

According to a ninth and a nineteenth aspect of the invention, the motor pump is driven when a change of the fluid temperature exceeds a predetermined value and the change is detected in the automatic transmission. By driving the motor pump, the amount of fluid supplied from the oil passage to a cooler can be increased. As a result, a large amount of fluid is forced to the cooler to be cooled even if the fluid temperature is increased. The performance of the automatic transmission can be improved by using the cooled fluid in, for example, the automatic transmission.

According to a tenth and a twentieth aspect of the invention, the automatic transmission attached to a vehicle employing an idle stop system is controlled. As a result, when the engine is restarted after a stop, not only the mechanical pump but also the motor pump is driven to prevent a response delay of the hydraulic circuit.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram showing a control device of an automatic transmission according to one embodiment of the present invention;

FIG. 2 is a flowchart showing a control process according to the embodiment of the present invention;

FIG. 3 is a flowchart showing a first driving process executed at step S3 in FIG. 2;

FIG. 4 is a flowchart showing a second driving process executed at step S6 in FIG. 2;

FIG. 5 is a flowchart showing a third driving process executed at step S9 in FIG. 2;

FIG. 6 is a flowchart showing a fourth driving process executed at step S11 in FIG. 2; and

FIG. 7 is a flowchart showing a fifth driving process executed at step S14 in FIG. 2.

### DETAILED DESCRIPTION OF THE PREFERRED EMBODIMENTS

The following description of the preferred embodiment is merely exemplary in nature and is in no way intended to limit the invention, its application, or uses.

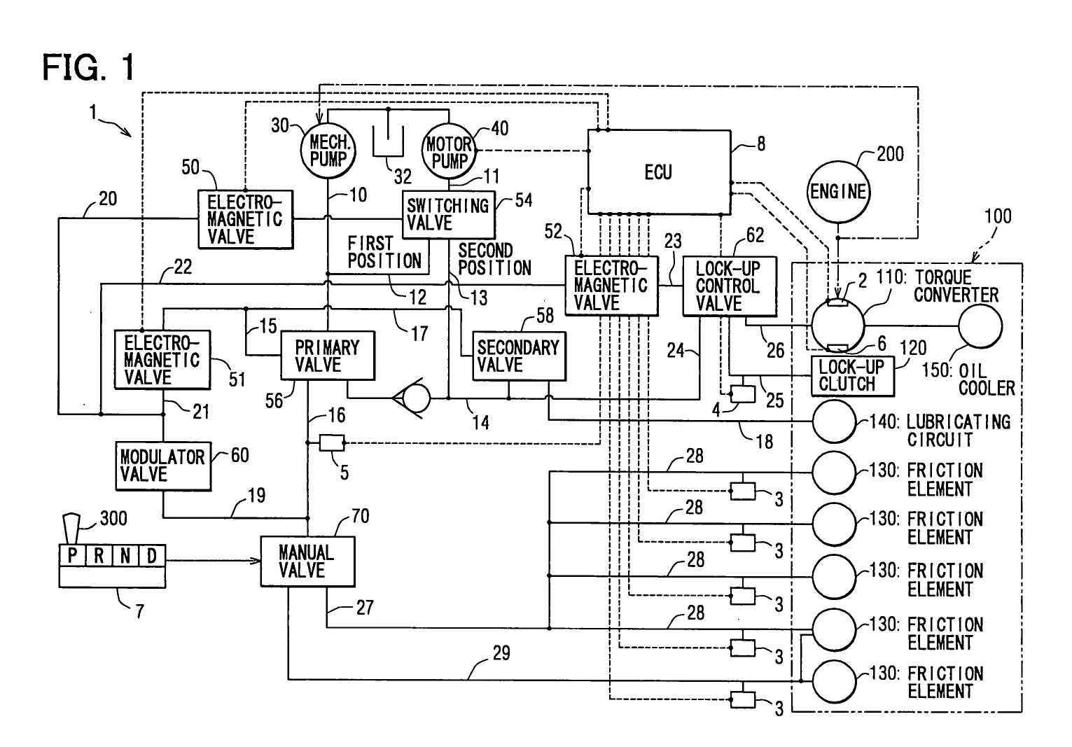

A control device of an automatic transmission according to an embodiment of the present invention is shown in FIG. 1. A control device 1 is attached to a vehicle together with an automatic transmission 100 and an engine 200 to control the automatic transmission 100. The vehicle, to which the control device 1 is attached, includes an idle stop system for stopping the engine 200 when the vehicle is stopped and for restarting the engine 200 when a predetermined condition is established.

First, the automatic transmission 100 will be described. The automatic transmission 100 includes a torque converter 110, a lock-up clutch 120, a plurality of friction elements 130, a lubricating circuit 140, and an oil cooler 150. A fluid is supplied from the control device 1 to the torque converter 110. The torque converter 110 in turn transmits a torque, which is input from the engine 200 to an input shaft (hereinafter, referred to as an “input-side torque”), through the fluid to an output shaft. The lock-up clutch 120 directly connects the input shaft and the output shaft of the torque converter 110 with each other or disconnects them in accordance with a pressure of the fluid supplied from the control device 1.

Each of the plurality of friction elements 130 is constituted by a clutch or a sheave, which is disengaged or engaged in accordance with a pressure of the fluid supplied from the control device 1. The range and the gear position of the automatic transmission 100 are changed in accordance with the combination of disengaged states and engaged states of the respective friction elements 130. The lubricating circuit 140 supplies the fluid supplied from the control device 1 to an engaged portion of each of the friction elements 130 to lubricate each of the friction elements 130. The lubricating circuit 140 supplies fluid not only to the friction elements 130 but also to a predetermined portion of the automatic transmission 100 to lubricate it.

An oil cooler 150 regulates the temperature of the fluid supplied from the control device 1 to pass through the torque converter 110. More specifically, the oil cooler 150 is composed of a heat exchanger for exchanging heat between the supplied fluid and cooling water of the engine 200. The oil cooler 150 can cool the fluid when the temperature of the fluid is higher than that of the cooling water, and it can warm the fluid when a temperature of the fluid is lower than that of the cooling water. Specifically, the oil cooler 150 serves as a cooler and a warmer.

Next, the control device 1 will be described. The control device 1 includes a hydraulic circuit, a plurality of sensors 2 to 7 acting as driving control means, and an electric control unit 8 (hereinafter, abbreviated as “ECU”). The hydraulic circuit of the control device 1 includes a plurality of oil passages 10 to 29, a mechanical pump 30, a motor pump 40, a plurality of electromagnetic valves 50 to 52, a switching valve 54, a primary valve 56, a secondary valve 58, a modulator valve 60, a lock-up control valve 62, a manual valve 70, and the like.

The mechanical pump 30 is connected to the oil passage 10 to discharge and supply the fluid drawn from an oil pan 32 to the oil passage 10. The mechanical pump 30 is mechanically driven in response to an output torque of the engine 200. As a result, the mechanical pump 30 operates in accordance with the revolutions of the engine 200.

The motor pump 40 is connected to the oil passage 11 to discharge and supply the fluid drawn from the oil pan 32 to the oil passage 11. The motor pump 40 is electrically connected to the ECU 8 to operate in accordance with an input command value from the ECU 8. The plurality of electromagnetic valves 50 to 52 are electrically connected to the ECU 8 to generate a command pressure in accordance with an input command value from the ECU 8, respectively.

The switching valve 54 is connected to an end of the oil passage 11, which is opposite to the motor pump side. In accordance with a command pressure of the electromagnetic valve 50, a spool of the switching valve 54 is switched between a first position at which the oil passage 11 is brought into communication with the oil passage 12 and a second position at which the oil passage 11 is brought into communication with the oil passage 13. An end of the oil passage 12, which is opposite to the switching valve 54 side, is connected to the middle of the oil passage 10. When the oil passage 11 and the oil passage 12 are in communication with each other, a fluid supplied from the mechanical pump 30 and a fluid supplied from the motor pump 40 merge within the oil passage 10. An end of the oil passage 13, which is opposite to the switching valve 54 side, is connected to the middle of the oil passage 14 provided between the primary valve 56 and the secondary valve 58.

The primary valve 56 is connected to the oil passage 15 for transmitting a command pressure of the electromagnetic valve 51 while being connected to an end of the oil passage 10, which is opposite to the mechanical pump 30 side. The primary valve 56 discharges a part of the fluid, which is introduced from the oil passage 10, from the oil passage 14 to the secondary valve 58. As a result, the primary valve 56 regulates the amount of fluid output to the oil passage 16. At this moment, the primary valve 56 regulates the amount of fluid in accordance with a command pressure of the electromagnetic valve 51 to regulate a pressure of the fluid to be output to a line pressure. The secondary valve 58 is connected to the oil passage 17 that branches from the oil passage 15 while being connected to an end of the oil passage 14, which is opposite to the primary valve side. The secondary valve 58 regulates the amount of fluid supplied from the oil passage 18 to the lubricating circuit 140 based on the amount of fluid discharged from the primary valve 56, which is introduced from the oil passage 14. The Regulation by the secondary valve 58 is executed in accordance with a command pressure of the electromagnetic valve 51.

The modulator valve 60 is connected to an oil passage 19 that branches from the oil passage 16. The modulator valve 60 regulates the pressure of the fluid, which serves as an initial pressure of the command pressures of the electromagnetic valves 50 to 52, to a modulated pressure that is lower than the line pressure. The modulated pressure is transmitted to the electromagnetic valves 50 to 52 by a plurality of oil passages 20 to 22.

The lock-up control valve 62 is connected to an oil passage 23 for transmitting the command pressure of the electromagnetic valve 52 while being connected to an oil passage 24 that branches from the oil passage 14. The lock-up control valve 62 brings any one of oil passages 25, 26 into communication with the oil passage 24 in accordance with a command pressure of the electromagnetic valve 52. An end of the oil passage 25, which is opposite to the lock-up control valve side, is connected to the lock-up clutch 120. When the oil passages 24, 25 are in communication with each other, the fluid discharged from the primary valve 56 is sequentially supplied from the oil passage 24 to the oil passage 25 and the lock-up clutch 120 so that a pressure of the discharged fluid is applied to the lock-up clutch 120. When the fluid pressure applied to the lock-up clutch 120 is higher than a predetermined value, the input shaft and the output shaft of the torque converter 110 are directly connected to each other. An end of the oil passage 26, which is opposite to the lock-up control valve side, is connected to the torque converter 110. When the oil passages 24, 26 are in communication with each other, the fluid discharged from the primary valve 56 is sequentially supplied from the oil passage 24 to the oil passage 26 and the torque converter 110, and in turn, to the oil cooler 150.

The manual valve 70 is connected to an end of the oil passage 16, which is opposite to the primary valve side. The manual valve 70 is also connected mechanically or electrically to a shift lever 300 of the vehicle. The manual valve 70 switches between the oil passages 27, 29 to be brought into communication with the oil passage 16 in accordance with a command of changing a shift position with the shift lever 300. For example, when the shift position is shifted to a parking (P) position or a neutral (N) position, the manual valve 70 prevents both the oil passages 27, 29 from being in communication with the oil passage 16. When the shift position is shifted to a drive (D) position, the manual valve 70 allows only the oil passage 27 to be in communication with the oil passage 16 so that the fluid at the line pressure is supplied from the oil passage 16 to the oil passage 27. When the shift position is shifted to a reverse (R) position, the manual valve 70 allows only the oil passage 29 to be in communication with the oil passage 16 so that the fluid at the line pressure is supplied from the oil passage 16 to the oil passage 29.

An end of the oil passage 27, which is opposite to the manual valve side, branches off in a plurality of oil passages 28. The plurality of oil passages 28 and the oil passage 29 are respectively connected to predetermined friction elements 130 to supply the fluid sent from the oil passage 16 in communication therewith to the friction elements 130. In this case, the friction elements 130, to which the oil passages 28 are respectively connected, are engaged at any of the gear positions when the range of the automatic transmission 100 is set at a drive (D) range in correspondence with the D-position. The friction element 130, to which the oil passage 29 is connected, is engaged when the range of the automatic transmission 100 is set to a reverse (R) range in correspondence with the R-position. Although not shown, in the middle of each of the oil passages 28, a regulator such as an electromagnetic valve or a pressure control valve for regulating the pressure of the fluid supplied from each of the oil passages 28 to each of the friction elements 130 to be in proportion to the line pressure is present. Specifically, such a regulator allows the regulated fluid pressure to be applied to the friction elements 130.

As described above, in this embodiment, the manual valve 70 allows switching between the oil passages 28, 29 for supplying the fluid to the friction elements 130 in accordance with a command to change the shift position.

The revolution number sensor 2 is provided in the torque converter 110 to detect the respective number of revolutions of the input shaft and the output shaft of the torque converter 110. The amount of torque input from the engine 200 can be detected based on the number of revolutions of the input shaft detected by the revolution number sensor 2. Moreover, an operating state of the engine 200 can also be detected based on the number of revolutions of the input shaft detected by the revolution number sensor 2.

A plurality of first pressure sensors 3 are provided for either the oil passages 28 or the oil passage 29 to detect a pressure of the fluid in the oil passages 28 or the oil passage 29, which corresponds to the pressure applied to the friction elements 130. It can be detected that each of the friction elements 130 is in a disengaged state or in an engaged state, based on the pressure of the fluid detected by each of the first pressure sensors 3. Furthermore, the gear position of the automatic transmission 100 can be detected based on the combination of the detected disengaged state and engaged state of the respective friction elements 130. The second pressure sensor 4 is provided in the oil passage 25 to detect a fluid pressure in the oil passage 25, which corresponds to a pressure applied to the lock-up clutch 120. The second pressure sensor 4 can detect that the input shaft and the output shaft of the torque converter 110 are in a directly connected state or a disconnected state based on the fluid pressure detected by the second pressure sensor 4.

The first temperature sensor 5 is provided, for example, in the oil passage 16 to detect a fluid temperature in the hydraulic circuit. The second temperature sensor 6 is provided in the torque converter 110 to detect a fluid temperature in the torque converter 110.

The position sensor 7 is provided, for example, in the vicinity of the shift lever 300 to detect a shift position, which is selected as a result of the operation of the shift lever 300. It can be detected to which oil passage, that is, the oil passages 28 or the oil passage 29, the oil passage for supplying the fluid to the friction elements 130 (hereinafter, referred to simply as a “supply oil passage”) is switched, based on the shift position detected by the position sensor 7. As described above, each of the sensors 2 to 7 whose operation is controlled by the electrically connected ECU 8 outputs a signal indicating the result of detection to the ECU 8.

The ECU 8 is mainly composed of a microcomputer, which includes a CPU and a storage device. The ECU 8 controls the motor pump 40, the electromagnetic valves 50 to 52, the sensors 2 to 7, and the like in accordance with a control program stored in the storage device.

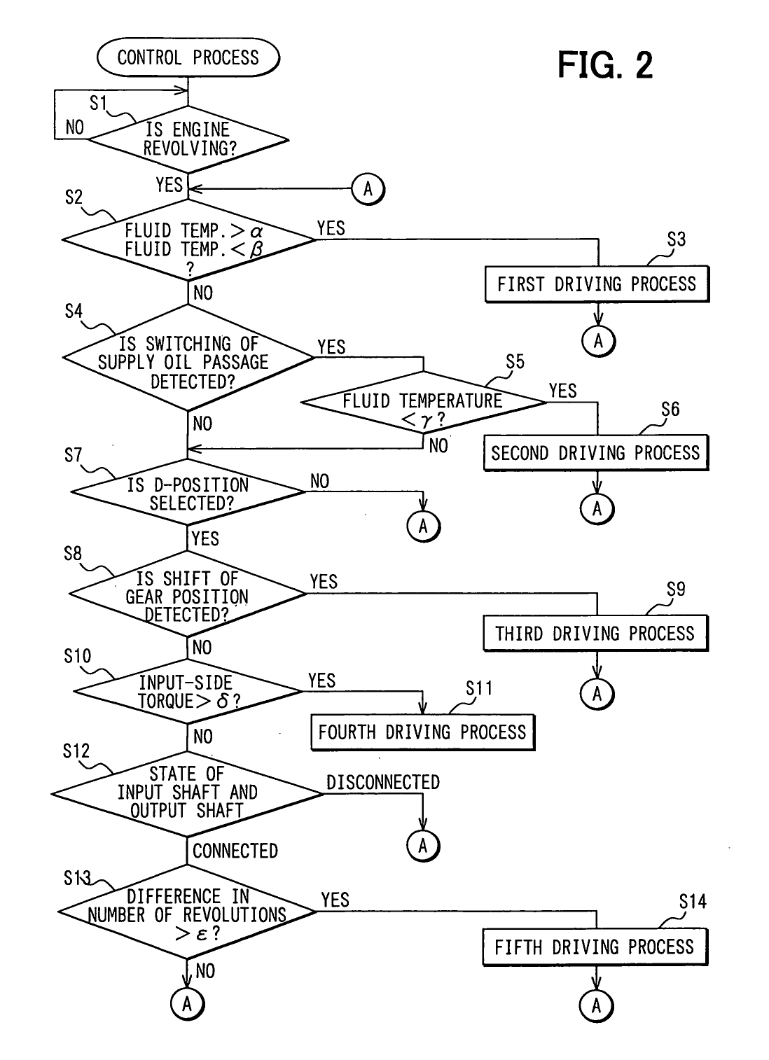

Herein, a control process executed by the ECU 8 in accordance with the control program will be described with reference to FIG. 2. The control process is started when the ECU 8 detects the start of the engine 200 based on an output signal from the revolution number sensor 2. On the other hand, the control process is terminated when the ECU 8 detects the stop of the engine 200. It is assumed that, at the start of the control process, the motor pump 40 is stopped and the lock-up control valve 62 brings the oil passage 26 into communication with the oil passage 24.

At step S1 of the control process it is determined based on an output signal from the revolution number sensor 2 whether the complete ignition of the engine 200 is achieved so that the engine is in a continuous operating state, that is, in a state where the engine revolves without any aid of the starter (hereinafter, referred to simply as a “revolving state”) or not. If it is determined that the engine 200 is in a revolving state, the process proceeds to step S2.

When the engine 200 is started, the fluid discharged from the mechanical pump 30 is supplied to, for example, the oil passages 10, 16, 18, 24, 26, and the like. When the engine 200 is restarted by the idle stop system, however, the fluid supply takes a long time. Therefore, at step S1, an input command value to the motor pump 40 may be temporarily changed to drive the motor pump 40 until the engine 200 enters the revolving state. As a result, the amount of fluid supplied to the oil passages is temporarily increased to increase the effectiveness of the hydraulic circuit.

At step S2, it is determined based on an output signal from the second temperature sensor 6, whether the fluid temperature in the torque converter 110 exceeds a predetermined threshold value α or is lower than another predetermined threshold value β, or not. In this case, the threshold value α is set slightly lower than the upper limit of the fluid temperature at which the torque converting performance of the torque converter 110 is degraded. The threshold value β is set slightly higher than the lower limit of the fluid temperature at which the torque converting performance of the torque converter 110 is degraded. If the fluid temperature exceeds the threshold value α or is lower than the threshold value β, the process proceeds to step S3 where a first driving process is executed. If the fluid temperature is equal to or higher than the threshold value β or is equal to or lower than the threshold value α, the process proceeds to step S4.

At step S4, the switching between the supply oil passages 28, 29 is detected based on an output signal from the position sensor 7. If the switching between the supply oil passages 28, 29 is detected within a set period of time, the process proceeds to step S5. If not, the process proceeds to step S7.

At step S5, it is determined based on an output signal from the first temperature sensor 5 whether the fluid temperature in the hydraulic circuit is lower than a predetermined threshold value γ or not. In this case, the threshold value γ is set slightly higher than the fluid temperature at which a shock is generated upon the engagement of the friction element 130 in a disengaged state along with the change in the shift position. If the fluid temperature is lower than the threshold value γ, the process proceeds to step S6 where a second driving process is executed. If the fluid temperature is equal to or higher than the threshold value γ, the process proceeds to step S7.

At step S7, it is determined based on an output signal from the position sensor 7 whether the D-position is selected by the shift lever 300 or not. If the D-position is selected, the process proceeds to step S8. If not, the process returns to step S2.

At step S8, a shift of the gear position in the automatic transmission 100 is detected based on an output signal from each of the first pressure sensors 3. If a shift of the gear position is detected within a set period of time, the process proceeds to step S9 where a third driving process is executed. If not, the process proceeds to step S10.

At step S10, an input-side torque of the torque converter 110 is detected based on an output signal from the revolution number sensor 2. In addition, it is determined whether the detected input-side torque exceeds a predetermined threshold value δ or not. In this case, the threshold value δ is set slightly smaller than the input-side torque at which sliding starts occurring in the friction elements 130 when in an engaged state. If the input-side torque exceeds the threshold value δ, the process proceeds to step S11 where a fourth driving process is executed. If the input-side torque is equal to or lower than the threshold value δ, the process proceeds to step S12.

At step S12, it is detected based on an output signal from the second pressure sensor 4 whether the input shaft and the output shaft of the torque converter 110 are in a directly connected state or a disconnected state. If the input shaft and the output shaft are in a directly connected state, the process proceeds to step S13. If the input shaft and the output shaft are in a disconnected state, the process returns to step S2.

At step S13, it is determined based on an output signal from the revolution number sensor 2 whether a difference in number of revolutions between the input shaft and the output shaft of the torque converter 110 exceeds a threshold value ε or not. Herein, the threshold value ε is set slightly smaller than a difference in number of revolutions at which a slide between the input shaft and the output shaft at their directly connected portion begins exceeding an allowable range. If the difference in the number of revolutions exceeds the threshold value ε, the process proceeds to step S14 where a fifth driving process is executed. If the difference in the number of revolutions is equal to or lower than the threshold value ε, the process proceeds to step S2.

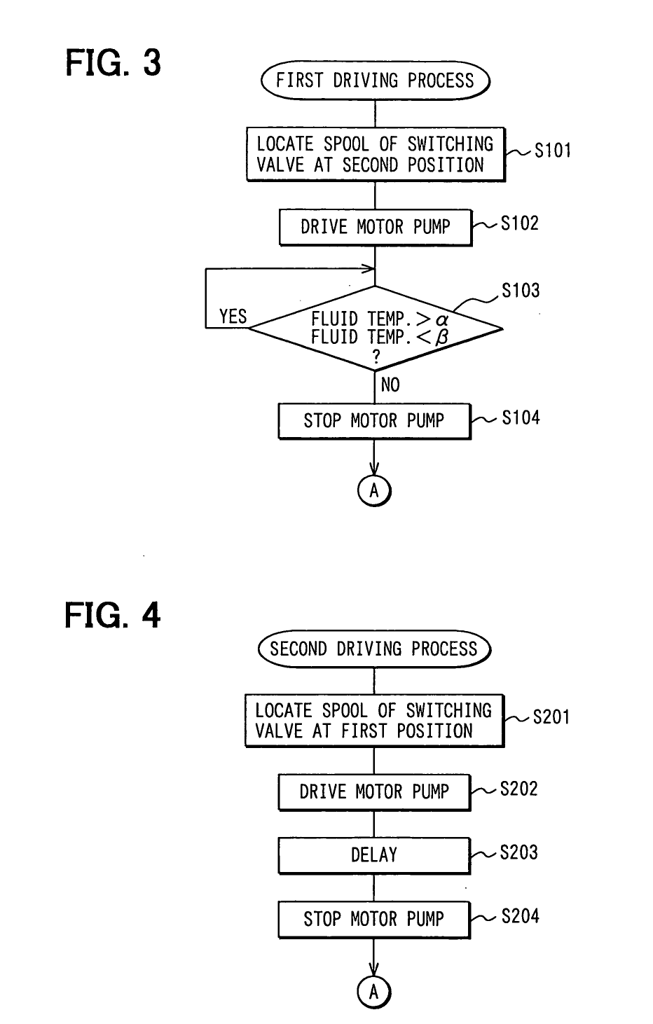

Hereinafter, the first to fifth driving processes executed respectively at step S3, step S6, step S9, step S11, and step S14 will be described in detail. First, the first driving process at step S3 will be described with reference to FIG. 3. At step S101 in the first driving process, the input command value to the electromagnetic value 50 is updated to locate the spool of the switching valve 54 at the second position. Subsequently, at step S102, the input command value to the motor pump 40 is changed to drive the motor pump 40. At step S103, the fluid temperature in the torque converter 110 is determined in the same manner as at step S2. If the fluid temperature is determined to be the threshold value β or larger and the threshold value α or lower, the process proceeds to step S104. At step S104, after the input command value to the motor pump 40 is changed to stop the motor pump 40, the process returns to step S2.

As described above, when the fluid temperature in the torque converter 110 exceeds the threshold value α or is lower than the threshold value β while the engine 200 is in a revolving state, the motor pump 40 is driven at step S102. Accordingly, the amount of fluid supplied to the oil passages 14, 24, and 26 and also to the torque converter 110 is increased. As a result, even if the fluid temperature is remarkably high, a large amount of fluid is supplied from the torque converter 110 to the oil cooler 150 to be cooled. On the other hand, even if the fluid temperature is remarkably low, a large amount of fluid is supplied from the torque converter 110 to the oil cooler 150 to be warmed. For example, if the cooled or warmed fluid is reused in the torque converter 110, the torque converting performance of the torque converter 110 is kept high. Moreover, if the cooled or warmed fluid is sent to the oil pan 32 to be used in the hydraulic circuit, the control performance of the hydraulic circuit can be kept high.

Next, the second driving process at step S6 will be described with reference to FIG. 4. At step S201 in the second driving process, the input command value to the electromagnetic value 50 is updated to locate the spool of the switching valve 54 at the first position. Subsequently, at step S202, the motor pump 40 is driven. At step S203, the transition to step S204 is delayed by a set period of time t1. At step S204, after the motor pump 40 is stopped, the process returns to step S2.

As described above, if the fluid temperature of the hydraulic circuit is lower than the threshold value γ when the switching between the supply oil passages 28, 29 occurs while the engine 200 is in a revolving state, the motor pump 40 is driven at step S202. Accordingly, the amount of fluid supplied to the oil passage 16 and also to the supply oil passages 28, 29 in communication with the oil passage 16 is increased. As a result, even if the fluid temperature is remarkably low, the fluid can be quickly supplied to the friction element 130 whose disengaged state is desired to be changed to an engaged state in accordance with a change in shift position. Therefore, any shock that is generated during the transition of the friction element 130 to the engaged state, can be reduced. The set period of time t1 corresponds to the amount of time for keeping the amount of fluid supplied to the supply oil passages 28, 29 increasing to prevent or lessen the shock generated during the engagement of the friction element 130.

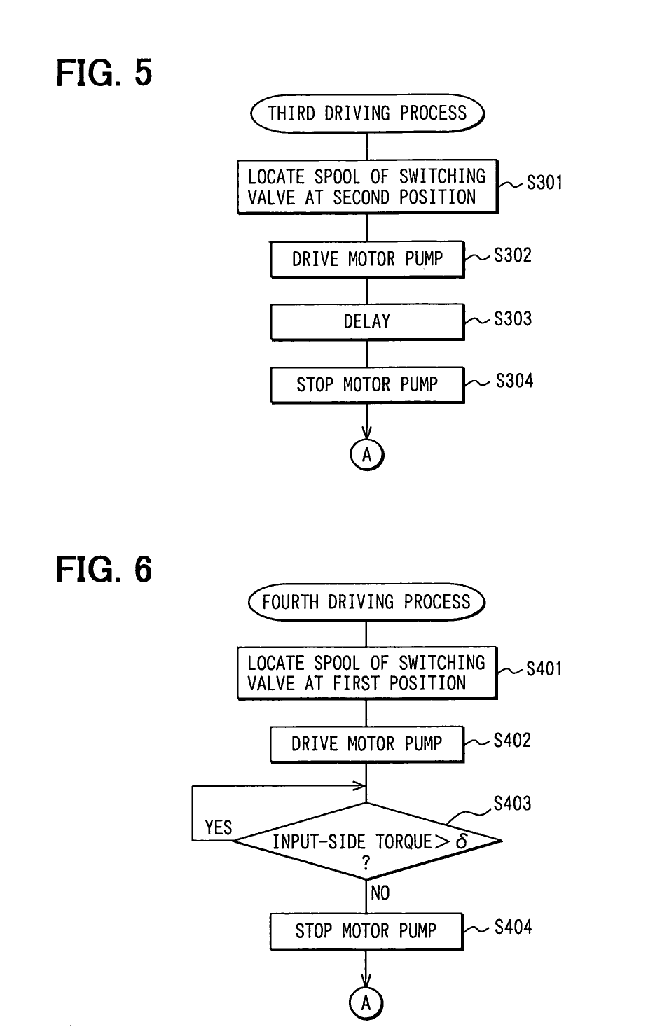

Next, the third driving process at step S9 will be described with reference to FIG. 5. At step S301 in the third driving process, the spool of the switching valve 54 is located at the second position. At step S302, the motor pump 40 is driven. At step S303, the transition to step S304 is delayed by a set period of time t2. At step S304, after the motor pump 40 is stopped, the process returns to step S2.

As described above, when the gear position of the automatic transmission 100 is shifted while the engine 200 is in a revolving state, the motor pump 40 is driven at step S302. Therefore, the amount of fluid supplied to the oil passages 14, 18 and also to the lubricating circuit 104 is increased. As a result, since a large amount of fluid serving as a lubricating oil is directed to the friction elements 130, lubricating performance is improved. Therefore, the friction elements 130, in particular, the friction element 130 which transits from the disengaged state to the engaged state along with a shift of the gear position, can be prevented from emitting heat. The above-described set period of time t2 corresponds to the amount of time keeping the amount of fluid supplied to the lubricating circuit 140 increasing to restrain the heat emission from the friction elements 130.

Next, the fourth driving process at step S11 will be described with reference to FIG. 6. At step S401 in the fourth driving process, the spool of the switching valve 54 is located at the first position. At step S402, the motor pump 40 is driven. At step S403, the input-side torque is determined in the same manner as at step S10. If the input-side torque becomes equal to or lower than the threshold value δ, the process proceeds to step S404. At step S404, after the motor pump 40 is stopped, the process returns to step S2.

As described above, when the input-side torque of the torque converter 110 exceeds the threshold value δ while the engine 200 is in a revolving state, the motor pump 40 is driven at step S402. Therefore, the amount of fluid supplied to the oil passage 16 and also to the supply oil passages 28 is increased. As a result, the fluid pressure applied from the supply oil passages 28 to the friction elements 130 in the engaged sate can be increased. Therefore, even if the input-side torque of the torque converter 110 is remarkably increased due to pressing on the accelerator or the like, sliding of the friction elements 130 in the engaged state can be prevented from occurring.

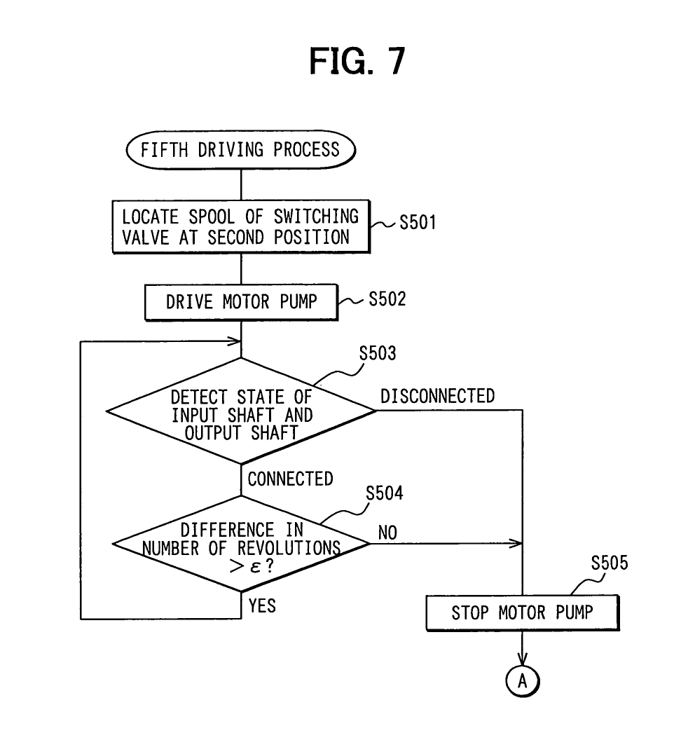

Next, the fifth driving process at step S14 will be described with reference to FIG. 7. At step S501 in the fifth driving process, the spool of the switching valve 54 is located at the second position. At step S502, the motor drive 40 is driven. At step S503, a state of the input shaft and the output shaft is detected in the same manner as at step S12. Subsequently, at step S504, a difference in the number of revolutions between the input shaft and the output shaft is determined in the same manner as at step S13. Then, when the input shaft and the output shaft are in a disconnected state, or when a difference in the number of revolutions is equal to or lower than the threshold value ε, the process proceeds to step S505. At step S505, after the motor pump 40 is stopped, the process returns to step S2.

As described above, when a difference in number of revolutions between the input shaft and the output shaft of the torque converter 110 exceeds the threshold value ε in the case where the input shaft and the output shaft are directly connected to each other while the engine 200 is in a revolving state, the motor pump 40 is driven at step S502. Therefore, the amount of fluid supplied to the oil passages 14, 24, and 25, and further to the lock-up clutch 120, is increased. As a result, the fluid pressure applied from the oil passage 25 to the lock-up clutch 120 can be increased. For example, when the vehicle runs at a low speed, the amount of discharge from the mechanical pump 30 is lowered because the engine 200 is in a low-speed revolving state. Thus, the pressure applied to the lock-up clutch 120 is lowered. In this case, even if the input shaft and the output shaft start sliding due to an increase in the input-side torque of the torque converter 110 or the like, which is caused by pressing on the accelerator, the pressure applied to the lock-up clutch 120 is increased as described above. Thus, the slide can be immediately stopped. Although the first to fifth driving processes are executed in the control process in the above-described embodiment, any of the first to fourth driving processes may be appropriately selected from the above-five processes to be executed.

In the above-described embodiment, after switching between the supply oil passages 28, 29 is detected in the control process, the fluid temperature of the hydraulic circuit is determined to drive the motor pump 40 when a reduction in shock is particularly required to conserve energy. Alternatively, the fluid temperature of the hydraulic circuit may be detected without detecting the switching between the supply oil passages 28, 29 to drive the motor pump 40. Additionally, the motor pump 40 may be driven when the switching between the supply oil passages 28, 29 is detected, regardless of the fluid temperature of the hydraulic circuit.

Furthermore, in the above-described embodiment, after the directly connected state between the input shaft and the output shaft of the torque converter 110 is detected in the control process, the difference in the number of revolutions between the shafts is determined. As a result, the motor pump 40 is driven only when restriction on sliding between the shafts is particularly required to conserve energy. Alternatively, the motor pump 40 may be driven after the determination of the difference in the number of revolutions without detecting the directly connected state between the input shaft and the output shaft.

Moreover, the warmer and the cooler are not required to be constituted as a single device (the oil cooler 150); instead, they can be constituted as two separate devices. Alternatively, the fluid may be actively heated or cooled by using a thermo-element and the like.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A control method of an automatic transmission, for controlling the automatic transmission by using a hydraulic circuit comprising:
a mechanical pump driven by an internal combustion engine;
a motor pump; and
an oil passage by which a fluid is supplied from the mechanical pump and the motor pump,
wherein the motor pump is driven when a change of state in the automatic transmission and the hydraulic circuit is detected while the internal combustion engine is revolving without any aid of a starter so that the mechanical pump supplies the fluid to the oil passage.

2. The control method of an automatic transmission according to claim 1, wherein
the automatic transmission includes a friction element that moves from a disengaged state to an engaged state and from an engaged state to a disengaged state according to a pressure of the fluid supplied from the oil passage; and
the motor pump is driven when a change of an input-side torque exceeding a predetermined value is detected in the automatic transmission.

3. The control method of an automatic transmission according to claim 1, wherein the automatic transmission includes a torque converter, and a lock-up clutch for directly connecting an input shaft and an output shaft of the torque converter with each other in accordance with a pressure of the fluid supplied from the oil passage; and
the motor pump is driven when a change that a difference in a number of revolutions between the input shaft and the output shaft exceeds a predetermined value is detected in the automatic transmission.

4. The control method of an automatic transmission according to claim 3, wherein the motor pump is driven when a directly connected state of the input shaft and the output shaft and a change such that the difference in the number of revolutions exceeding the predetermined value are detected in the automatic transmission.

5. The control method of an automatic transmission according to claim 1, wherein
the automatic transmission includes a friction element for shifting a gear position by transitioning from a disengaged state to an engaged state or from an engaged state to a disengaged state, and a lubricating circuit for lubricating the friction element with the fluid supplied from the oil passage; and
the motor pump is driven when a shift of a gear position is detected in the automatic transmission.

6. The control method of an automatic transmission according to claim 1, wherein
the automatic transmission includes a plurality of friction elements for transiting from one of a disengaged state and an engaged state to the other state in accordance with a pressure of the fluid supplied from the oil passage;
the hydraulic circuit includes a manual valve for switching the plurality of oil passages for supplying the fluid to the plurality of friction elements in accordance with a command of changing a shift position; and
the motor pump is driven when a change of a fluid temperature becomes lower than a predetermined value is detected in the hydraulic circuit.

7. The control method of an automatic transmission according to claim 1, wherein
the automatic transmission includes a plurality of friction elements for transiting from one of a disengaged state and an engaged state to the other state in accordance with a pressure of the fluid supplied from the oil passage;
the hydraulic circuit includes a manual valve for switching the plurality of oil passages for supplying the fluid to the plurality of friction elements in accordance with a command of changing a shift position; and
the motor pump is driven when a change such that the oil passages are switched by the manual valve is detected in the hydraulic circuit.

8. The control method of an automatic transmission according to claim 1, wherein the automatic transmission includes a warmer for warming the fluid supplied from the oil passage; and
the motor pump is driven when a change such that a fluid temperature becomes lower than a predetermined value is detected in the automatic transmission.

9. The control method of an automatic transmission according to claim 1, wherein the automatic transmission includes a cooler for cooling the fluid supplied from the oil passage; and
the motor pump is driven when a change such that a fluid temperature exceeds a predetermined value is detected in the automatic transmission.

10. The control method of an automatic transmission according to claim 1, for controlling the automatic transmission attached to a vehicle including an idle stop system.

11. A control device of an automatic transmission, for controlling the automatic transmission, comprising:
a hydraulic circuit including:
a mechanical pump driven by an internal combustion engine;
a motor pump; and
an oil passage to which a fluid is supplied from the mechanical pump and the motor pump; and
driving control means for driving the motor pump when a change of state in the automatic transmission and the hydraulic circuit is detected while the internal combustion engine revolves without any aid of a starter so that the mechanical pump supplies the fluid to the oil passage.

12. The control device of an automatic transmission according to claim 11, wherein the automatic transmission includes a friction element that moves from one of a disengaged state and an engaged state to the other state in accordance with a pressure of the fluid supplied from the oil passage; and
the driving control means drives the motor pump when a change such that an input-side torque exceeds a predetermined value is detected in the automatic transmission.

13. The control device of an automatic transmission according to claim 11, wherein the automatic transmission includes a torque converter and a lock-up clutch for directly connecting an input shaft and an output shaft of the torque converter to each other in accordance with a pressure of the fluid supplied from the oil passage; and
the driving control means drives the motor pump when a difference in a number of revolutions between the input shaft and the output shaft exceeds a predetermined value is detected in the automatic transmission.

14. The control device of an automatic transmission according to claim 13, wherein the driving control means drives the motor pump when a directly connected state of the input shaft and the output shaft and a change in a number of revolutions exceeds the predetermined value are detected in the automatic transmission.

15. The control device of an automatic transmission according to claim 11, wherein the automatic transmission includes a friction element for shifting a gear position by transitioning from one of a disengaged state and an engaged state to the other state, and a lubricating circuit for lubricating the friction element with the fluid supplied from the oil passage; and
the driving control means drives the motor pump when a shift of the gear position is detected in the automatic transmission.

16. The control device of an automatic transmission according to claim 11, wherein
the automatic transmission includes a plurality of friction elements for transiting from one of a disengaged state and an engaged state to the other state in accordance with a pressure of the fluid supplied from the oil passage;
the hydraulic circuit includes a manual valve for switching the plurality of oil passages for supplying the fluid to the plurality of friction elements in accordance with a command to change a shift position; and
the driving control means drives the motor pump upon detection of a fluid temperature that is lower than a predetermined temperature in the hydraulic circuit.

17. The control device of an automatic transmission according to claim 11, wherein
the automatic transmission includes a plurality of friction elements for transiting from one of a disengaged state and an engaged state to the other state in accordance with a pressure of the fluid supplied from the oil passage;
the hydraulic circuit includes a manual valve for switching a plurality of the oil passages for supplying the fluid to the plurality of friction elements in accordance with a command of changing a shift position; and
the driving control means drives the motor pump when a change such that the oil passages are switched by the manual valve is detected in the hydraulic circuit.

18. The control device of an automatic transmission according to claim 11, wherein
the automatic transmission includes a warmer for warming the fluid supplied from the oil passage; and
the driving control means drives the motor pump when a change in a fluid temperature becomes lower than a predetermined value is detected in the automatic transmission.

19. The control device of an automatic transmission according to claim 11, wherein the automatic transmission includes a cooler for cooling the fluid supplied from the oil passage; and
the driving control means drives the motor pump when a change of a fluid temperature exceeding a predetermined value is detected in the automatic transmission.

20. The control device of an automatic transmission according to claim 11, for controlling the automatic transmission attached to a vehicle including an idle stop system.
